(19) United States
(12) Patent Application Publication
(10) Pub. No.: US 2024/0373927 A1
(43) Pub. Date: Nov. 14, 2024

(54) AEROSOL-GENERATING DEVICE

(71) Applicant: KT&G CORPORATION, Daejeon (KR)

(72) Inventors: Taehun KIM, Gyeonggi-do (KR); Jueon PARK, Seoul (KR); Hyungjin JUNG, Seoul (KR); Jungho HAN, Daejeon (KR)

(73) Assignee: KT&G CORPORATION, Daejeon (KR)

(21) Appl. No.: 18/696,320

(22) PCT Filed: Oct. 14, 2022
(86) PCT No.: PCT/KR2022/015647

§ 371 Date: Mar. 27, 2024

(30) Foreign Application Priority Data
Oct. 20, 2021 (KR) 10-2021-0140613
Feb. 17, 2022 (KR) 10-2022-0020942

(51) Int. Cl. A24F 40/46; A24F 40/20; A24F 40/70; B23K 26/24

(52) U.S. Cl. CPC A24F 40/46; A24F 40/20; A24F 40/70; B23K 26/24

(57) ABSTRACT

An aerosol-generating device is disclosed. The aerosol-generating device of the disclosure includes a heating assembly configured to surround a first insertion space that is open at an upper portion and at a lower portion; a lower pipe disposed below the heating assembly to be parallel to the heating assembly and to support a lower end of the heating assembly; an upper pipe configured to support an upper end of the heating assembly and extending downwards to cover a circumference of the heating assembly, the upper pipe having a circumference overlapping a circumference of the lower pipe along a radial direction; a light-transmitting portion located on one of the lower pipe or the upper pipe at a position corresponding to the overlap; and a light-absorbing portion located on the other one of the lower pipe or the upper pipe at the position corresponding to the overlap and integrally coupled to an inner circumferential surface of the light-transmitting portion.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to seal a gap in a structure in which air flows.

It is still another object of the present disclosure to stably assemble a structure.

It is still another object of the present disclosure to improve the flow efficiency of air.

### Technical Solution

In accordance with an aspect of the present disclosure for accomplishing the above and other objects, there is provided an aerosol-generating device including includes a heating assembly configured to surround a first insertion space that is open at an upper portion and at a lower portion; a lower pipe disposed below the heating assembly to be parallel to the heating assembly and to support a lower end of the heating assembly; an upper pipe configured to support an upper end of the heating assembly and extending downwards to cover a circumference of the heating assembly, the upper pipe having a circumference overlapping a circumference of the lower pipe along a radial direction; a light-transmitting portion located on one of the lower pipe or the upper pipe at a position corresponding to the overlap; and a light-absorbing portion located on the other one of the lower pipe or the upper pipe at the position corresponding to the overlap and integrally coupled to an inner circumferential surface of the light-transmitting portion.

### Advantageous Effects

According to at least one of embodiments of the present disclosure, it may be possible to seal a gap in a structure in which air flows.

According to at least one of embodiments of the present disclosure, it may be possible to stably assemble a structure.

According to at least one of embodiments of the present disclosure, it may be possible to improve the flow efficiency of air.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

FIGS. 1 to 9 are views showing examples of an aerosol-generating device according to embodiments of the present disclosure.

### MODE FOR INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

With respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

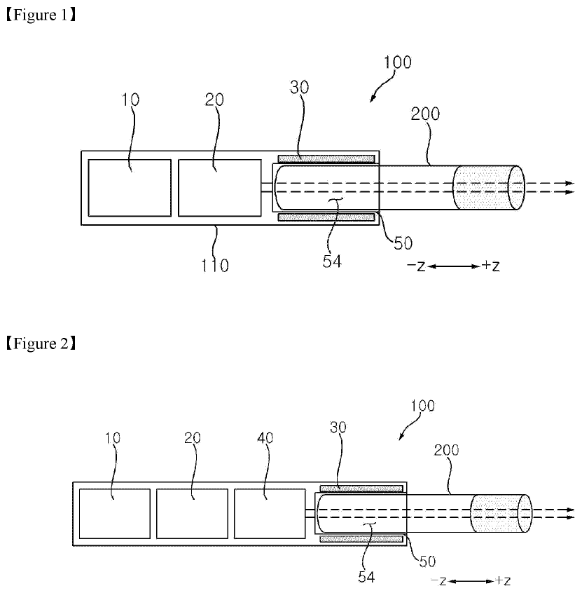

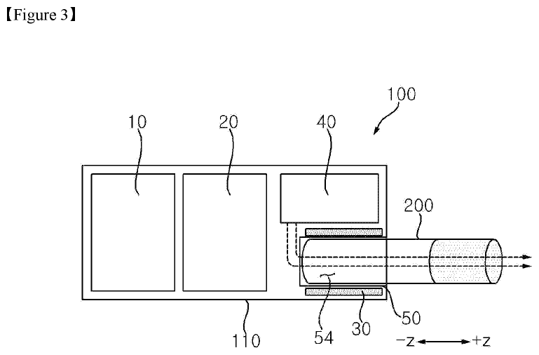

Referring to FIG. 1, an aerosol-generating device 100 may include at least one of a battery 10, a controller 20, or a heating assembly 30. Referring to FIGS. 2 and 3, the aerosol-generating device 100 may further include a cartridge 40.

Referring to FIG. 1, the battery 10, the controller 20, and the heating assembly 30 may be disposed in a line. Referring to FIG. 2, the battery 10, the controller 20, the heating assembly 30, and the cartridge 40 may be disposed in a line. Referring to FIG. 3, the cartridge 40 and the heating assembly 30 may be disposed parallel to each other so as to face each other. The internal structure of the aerosol-generating device 100 is not limited to that shown in the drawings.

The aerosol-generating device 100 may have an insertion space 54 defined therein. The insertion space 54 may be open in the upward direction of the aerosol-generating device 100. The insertion space 54 may have a cylindrical shape that is elongated in the vertical direction. A stick 200 may be inserted into the insertion space 54.

The heating assembly 30 may be disposed around the insertion space 54. The heating assembly 30 may have a cylindrical shape that surrounds the insertion space 54 and has open upper and lower ends. The heating assembly 30 may surround one side of the stick 200 inserted into the insertion space 54. The heating assembly 30 may heat the insertion space and/or the stick 200 inserted into the insertion space 54 to generate an aerosol.

The battery 10 may supply power to operate at least one of the controller 20, the heating assembly 30, or the cartridge 40. The battery 10 may supply power required for driving a display, a sensor, a motor, etc. mounted in the aerosol-generating device 100.

The controller 20 may control the overall operation of the aerosol-generating device 100. The controller 20 may control the operation of at least one of the battery 10, the heating assembly 30, or the cartridge 40. The controller 20 may control the operation of the display, the sensor, the motor, etc. mounted in the aerosol-generating device 100. The controller 20 may check the state of each of the components of the aerosol-generating device 100 to determine whether the aerosol-generating device 100 is in an operable state.

The cartridge 40 may store liquid therein. The cartridge 40 may generate an aerosol using the liquid stored therein. The aerosol generated in the cartridge 40 may be delivered to a user via the stick 200 inserted into the aerosol-generating device 100.

The cartridge 40 may include a liquid chamber in which liquid is stored and an atomizing chamber in which an aerosol is generated and through which air passes. The cartridge 40 may include a wick disposed in the atomizing chamber to receive the liquid from the liquid chamber. The cartridge 40 may include a heating coil configured to heat the wick to generate an aerosol. Air introduced into an inlet of the cartridge 40 may pass through the liquid chamber, and may be discharged through an outlet of the cartridge 40 together with an aerosol.

The lower end of the stick 200 may be inserted into the insertion space 54, and the upper end thereof may be exposed to the outside from the insertion space 54. The user may inhale air in the state of holding the exposed upper end of the stick 200 in the mouth. The air may pass through the aerosol-generating device 100, and may then be delivered to the user together with an aerosol.

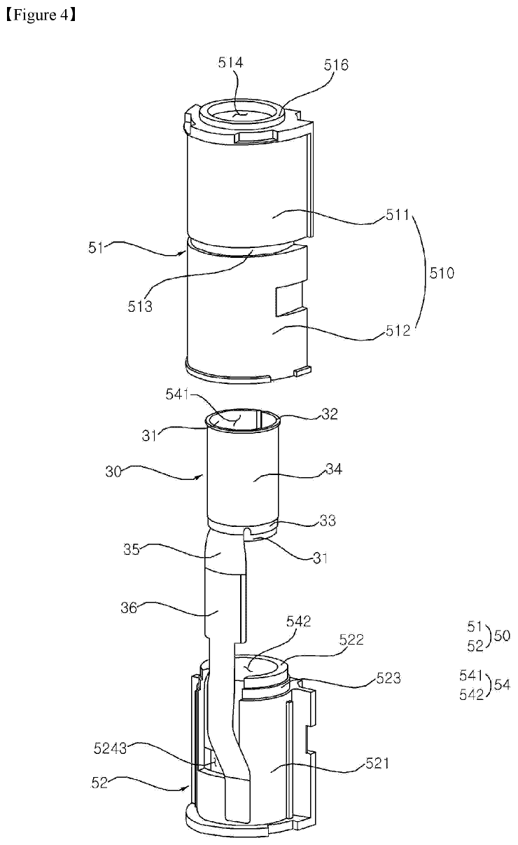

Referring to FIG. 4, a lower pipe 52 may be inserted into an upper pipe 51 from below. The heating assembly 30 may be inserted into the upper pipe 51. The heating assembly 30 may be disposed between the upper end of the upper pipe 51 and the upper end of the lower pipe 52. The upper pipe 51 and the lower pipe 52 may be coupled to each other, with the heating assembly 30 interposed therebetween.

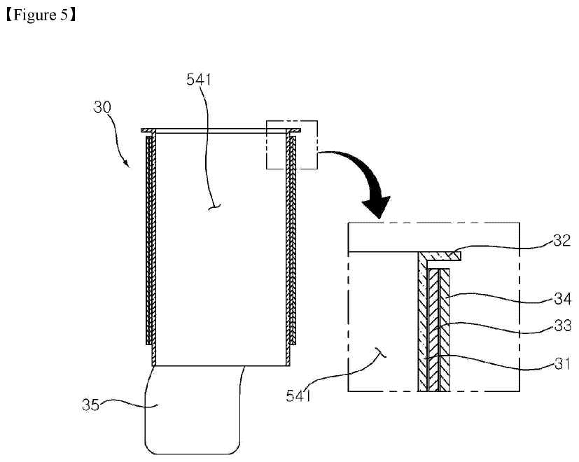

Referring to FIGS. 4 and 5, the heating assembly 30 may have a pipe shape extending in the vertical direction. The heating assembly 30 may have a cylindrical shape. The heating assembly 30 may have a first insertion space 541 defined therein. The first insertion space 541 may have a cylindrical shape extending in the vertical direction. The first insertion space 541 may be open upwards and downwards. The upper end of the first insertion space 541 may be open to the outside.

The heating assembly 30 may include a heating body 31. The heating body 31 may have a cylindrical shape extending in the vertical direction. The heating body 31 may surround the first insertion space 541. The heating body 31 may be open upwards and downwards. The heating body 31 may be made of a material having high thermal conductivity. The heating body 31 may support a heating element 33.

The heating assembly 30 may include a heating flange 32. The heating flange 32 may be integrally formed with the heating body 31. The heating flange 32 may protrude in the radially outward direction from the upper end of the heating body 31. The heating flange 32 may extend in the circumferential direction. The heating flange 32 may have a ring shape.

The heating assembly 30 may include a heating element 33. The heating element 33 may have a cylindrical shape extending in the vertical direction. The heating element 33 may surround the outer circumferential surface of the heating body 31. The inner circumferential surface of the heating element 33 may be in contact with and attached to the outer circumferential surface of the heating body 31. The upper end of the heating element 33 may be covered by the heating flange 32. The heating element 33 may generate heat to heat the first insertion space 541. The heating element 33 may be an electrically resistive heater. The heating element 33 may be made of a conductive metal.

The heating assembly 30 may include a heat insulating layer 34. The heat insulating layer 34 may have a cylindrical shape extending in the vertical direction. The heat insulating layer 34 may surround the outer circumferential surface of the heating element 33. The heat insulating layer 34 may prevent the heat generated from the heating element 33 from being radiated to the outside, rather than to the first insertion space 541.

A first connector 35 may be elongated downwards from the lower end of the heating element 33. The first connector 35 may be integrally formed with the heating element 33. The first connector 35 may be made of a conductive metal. The first connector 35 may be connected to a second connector 36, and the second connector 36 may be connected to the battery 10 and/or the controller 20. The second connector 36 may transmit power to the first connector 35. Accordingly, the heating element 33 may receive power.

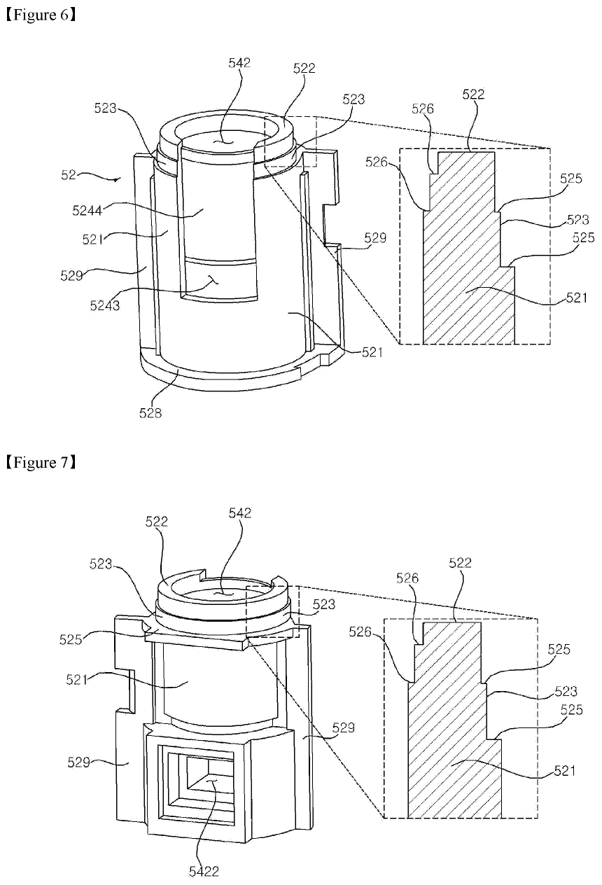

Referring to FIGS. 4, 6, and 7, the circumference 521 of the lower pipe 52 may have a cylindrical shape extending in the vertical direction. The lower pipe 52 may be disposed in the lower portion of the upper pipe 51. The circumference 521 may be referred to as a side wall 521.

The lower pipe 52 may have a second insertion space 542 defined therein. The circumference 521 of the lower pipe 52 may surround the circumference of the second insertion space 542. The second insertion space 542 may have a cylindrical shape that is open upwards and downwards.

A light-absorbing portion 523 may be formed on the outer circumferential surface of the upper circumference 521 of the lower pipe 52. The light-absorbing portion 523 may extend in the circumferential direction along the outer circumferential surface of the circumference 521. The light-absorbing portion 523 may have a “C” shape or an “O” shape. The light-absorbing portion 523 may be oriented in the radially outward direction.

A first support rib 525 may be formed on the outer circumferential surface of the circumference 521 of the lower pipe 52. The first support rib 525 may be formed on the periphery of the light-absorbing portion 523. The first support rib 525 may protrude in the radially outward direction from the upper end and/or the lower end of the light-absorbing portion 523 so as to be oriented in the upward direction. However, the position of the first support rib 525 is not limited thereto. The first support rib 525 may extend in the circumferential direction along the light-absorbing portion 523. The first support rib 525 may form a step on the circumference 521.

The upper surface 522 of the circumference 521 of the lower pipe 52 may extend in the circumferential direction along the circumference 521. The upper surface 522 may be oriented in the upward direction of the lower pipe 52. The upper surface 522 may have a “C” shape or an “O” shape.

A heater support rib 526 may be formed on the upper end of the circumference 521 of the lower pipe 52. The heater support rib 526 may be formed in such a manner that the upper end of the inner circumferential surface of the circumference 521 of the lower pipe 52 is recessed in the radially outward direction. The heater support rib 526 may form a step on the upper end of the inner circumferential surface of the circumference 521 of the lower pipe 52. The heater support rib 526 may be adjacent to the upper surface 522. The heater support rib 526 may face the second insertion space 542 in the radially inward direction.

One side of the circumference 521 of the lower pipe 52 may be depressed in the radially inward direction to form a depressed groove 5244. The depressed groove 5244 may extend to the upper surface 522 of the circumference 521 of the lower pipe 52. The depressed groove 5244 may be formed between both ends of the C-shaped light-absorbing portion 523. One side of the circumference 521 of the lower pipe 52 may be open to form a connecting hole 5243. The connecting hole 5243 may be located below the depressed groove 5244. The first connector 35 may be inserted into and disposed in the depressed groove 5244. The first connector 35 and the second connector 36 may pass through the connecting hole 5243, and may be connected to each other.

A base 528 may protrude in the radially outward direction from the outer circumferential surface of the lower end of the circumference 521 of the lower pipe 52. The base 528 may extend in the circumferential direction along the circumferential 521.

A support bar 529 may be elongated upwards along the circumference 521 of the lower pipe 52 from the base 528. The support bar 529 may protrude in the radially outward direction from the circumference 521. The support bar 529 may be formed on each of two opposite sides of the lower pipe 52.

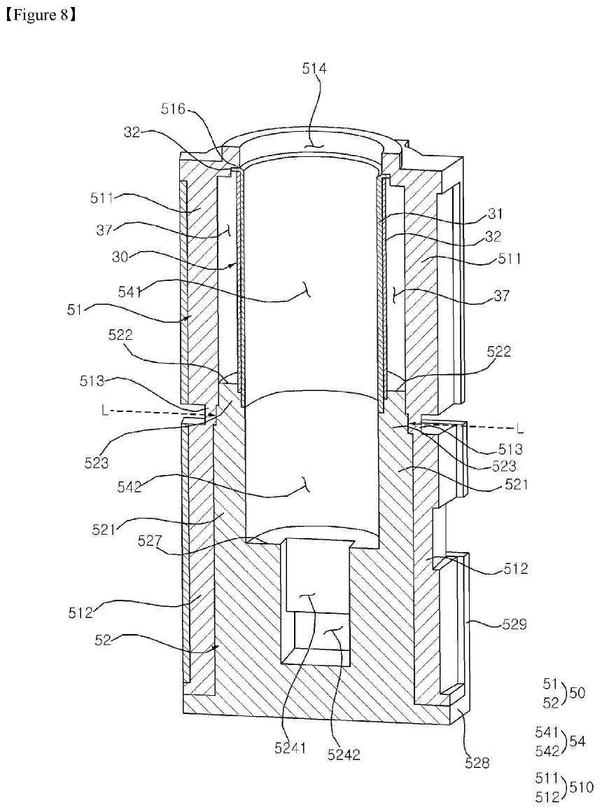

An inlet 5422 may be formed in such a manner that the lower portion of one side of the circumference 521 of the lower pipe 52 is open. The inlet 5422 may communicate with a connecting passage 5421 (refer to FIG. 8). The cartridge 40 (refer to FIGS. 2 and 3) may communicate with the inlet 5422. Accordingly, the air and/or the aerosol that pass through the cartridge 40 and are discharged through the outlet of the cartridge 40 may be introduced into the inlet 5422.

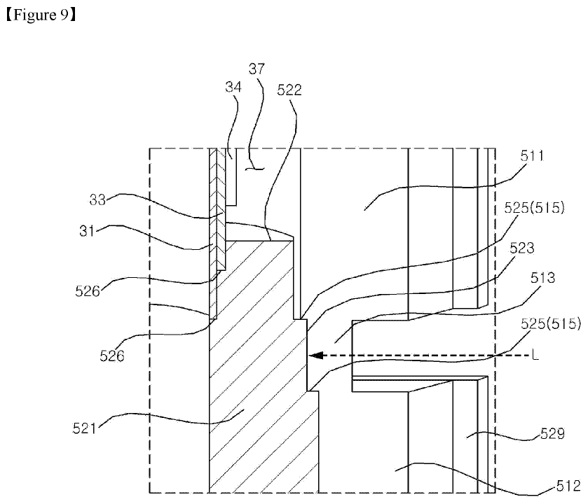

Referring to FIGS. 4 and 8 to 10, the upper pipe 51 may have a hollow shape having a cavity. The upper pipe 51 may have a cylindrical inner circumferential surface surrounding the cavity. The cavity may be open upwards to form an opening 514. The opening 514 may be formed in such a manner that the upper end of the upper pipe 51 is open. The opening 514 may be surrounded by a pipe flange 516. The opening 514 may communicate with the first insertion space 541 at a position corresponding to the upper side of the first insertion space 541.

The circumference 510 of the upper pipe 51 may be elongated in the vertical direction. The circumference 510 of the upper pipe 51 may include an upper circumference 511 and a lower circumference 512 located beneath the upper circumference 511. The circumference 510 may be referred to as a side wall 510. The upper circumference 511 may be referred to as an upper side wall 511. The lower circumference 512 may be referred to as a lower side wall 512.

The inner circumferential surface of the upper circumference 511 of the upper pipe 51 may surround the outer circumferential surface of the heating assembly 30. The inner circumferential surface of the lower circumference 512 of the upper pipe 51 may surround the outer circumferential surface of the upper portion of the circumference 521 of the lower pipe 52.

The pipe flange 516 may be integrally formed with the upper end of the upper pipe 51. The pipe flange 516 may be located above the heating assembly 30. The pipe flange 516 may protrude in the radially inward direction from the inner circumferential surface of the upper end of the upper circumference 511 of the upper pipe 51. The pipe flange 516 may extend in the circumferential direction. The pipe flange 516 may support the upper end of the heating assembly 30. The pipe flange 516 may support the upper end of the heating body 31 or the heating flange 32. The pipe flange 516 may overlap the circumference of the heating assembly 30 in the vertical direction.

The circumference 510 of the upper pipe 51 may extend in the downward direction of the heating assembly 30. The circumference 510 of the upper pipe 51 may include a portion overlapping the circumference 521 of the lower pipe 52 in the radial direction. Coupling portions 513 and 523 may be formed at a portion at which the circumference 510 of the upper pipe 51 and the circumference 521 of the lower pipe 52 overlap each other in the radial direction. The coupling portions 513 and 523 may be adjacent to the heating assembly 30.

The outer circumferential surface of the circumference 521 of the lower pipe 52 may be surrounded by the inner circumferential surface of the lower circumference 510 of the upper pipe 51. The upper end of the circumference 521 of the lower pipe 52 may be located below the pipe flange 516.

The upper end of the upper pipe 51 or the pipe flange 516 may support the upper end of the heating assembly 30. The upper end of the circumference 521 of the lower pipe 52 or the heater support rib 526 may support the lower end of the heating assembly 30. The heater support rib 526 may extend in the circumferential direction along the circumference of the lower end of the heating assembly 30. The inner circumferential surface of the heating body 31 may be parallel to the inner circumferential surface of the circumference 521 of the lower pipe 52.

The upper circumference 511 of the upper pipe 51 may be spaced outwards from the circumference of the heating assembly 30 to form an air gap 37. The heat insulating layer 34 and the air gap 37 may be formed between the heating element 33 and the upper circumference 511 of the upper pipe 51.

Accordingly, the heating assembly 30 may be stably supported. In addition, it is possible to prevent the heat generated from the heating assembly 30 from thermally deforming the device.

The second insertion space 542 may be located beneath the first insertion space 541. The second insertion space 542 may communicate with the first insertion space 541. The circumference of the second insertion space 542 may correspond to the circumference of the first insertion space 541. The first insertion space 541 and the second insertion space 542 may form the shape of a continuous cylinder. The second insertion space 542 may extend downwards from the first insertion space 541. The insertion space 54 may include the first insertion space 541 and the second insertion space 542. The stick 200 (refer to FIGS. 1 to 3) may be inserted into the insertion space 54. The height of the first insertion space 541 may correspond to the height of a medium included in the stick 200 (refer to FIGS. 1 to 3) inserted into the insertion space 54. Accordingly, the heating element 33 may heat the medium in the stick 200 to generate an aerosol.

The lower pipe 52 may include a stick supporter 527. The stick supporter 527 may cover at least a portion of the lower end of the second insertion space 542. The stick supporter 527 may protrude in the radially inward direction from the inner circumferential surface of the lower portion of the circumference 521 of the lower pipe 52. The stick supporter 527 may extend in the circumferential direction along the inner circumferential surface of the circumference 521 of the lower pipe 52. The lower end of the stick 200 (refer to FIGS. 1 to 3) inserted into the insertion space 54 may be supported by the stick supporter 527, and thus the stick 200 may be prevented from being further inserted.

A connecting passage 5241 may be formed beneath the second insertion space 542. The connecting passage 5241 may be surrounded by the stick supporter 527. The connecting passage 5241 may extend downwards from the second insertion space 542. The connecting passage 5241 may be located between the second insertion space 542 and the inlet 5242. The upper end of the connecting passage 5241 may communicate with the second insertion space 542. One side of the lower portion of the connecting passage 5241 may communicate with the inlet 5242. The air and/or the aerosol introduced into the inlet 5242 may pass through the connecting passage 5241, and may then be supplied to the stick 200 (refer to FIGS. 1 to 3) inserted into the insertion space 54.

The coupling portions 513 and 523 may include a light-transmitting portion 513 and a light-absorbing portion 523. The light-transmitting portion 513 may be formed on one of the lower pipe 52 and the upper pipe 51, and the light-absorbing portion 523 may be formed on the other of the lower pipe 52 and the upper pipe 51.

For example, the light-transmitting portion 513 may be formed on one side of the circumference 510 of the upper pipe 51, and the light-absorbing portion 523 may be formed on one side of the circumference 521 of the lower pipe 52. The light-transmitting portion 513 and the light-absorbing portion 523 may overlap each other in the radial direction, and may be in contact with each other. The light-absorbing portion 523 may be coupled to the inner circumferential surface of the light-transmitting portion 513. The outer circumferential surface of the light-absorbing portion 523 and the inner circumferential surface of the light-transmitting portion 513 may extend in the circumferential direction in shapes corresponding to each other.

In another example, the circumference 510 of the upper pipe 51 may be disposed on the inner circumferential surface of the circumference 521 of the lower pipe 52, the light-transmitting portion 513 may be formed on the circumference of the lower pipe 52, and the light-absorbing portion 523 may be formed on the circumference 510 of the upper pipe 51 (refer to FIGS. 11 and 12).

The light-transmitting portion 513 may be formed between the upper circumference 511 of the upper pipe 51 and the lower circumference 512 thereof. The light-transmitting portion 513 may be light transmissive. For example, the light-transmitting portion 513 may be made of a light-transmissive plastic. A laser beam L may pass through the light-transmitting portion 513. The light transmittance of the light-transmitting portion 513 may be 30% or more.

The light-absorbing portion 523 may be formed on the upper end of the circumference 521 of the lower pipe 52. The light-absorbing portion 523 may be light absorptive. For example, the light-absorbing portion 523 may be made of a light absorptive plastic. The laser may not pass through the light-absorbing portion 523.

The outer circumferential surface of the light-absorbing portion 523 and the inner circumferential surface of the light-transmitting portion 513 may be coupled to each other through a laser-welding method. The laser beam L may be radiated from the outside of the light-transmitting portion 513 toward the light-absorbing portion 523. The radiated laser beam L may pass through the light-transmitting portion 513, and may then be absorbed by the outer circumferential surface of the light-absorbing portion 523. The outer circumferential surface of the light-absorbing portion 523 may absorb the laser beam L, and thus may generate heat and fuse. The heat of fusion of the light-absorbing portion 523 may heat and fuse the inner circumferential surface of the light-transmitting portion 513. In this case, the inner circumferential surface of the light-transmitting portion 513 and the outer circumferential surface of the light-absorbing portion 523 may be brought into close contact with each other by pressure. In addition, the inner circumferential surface of the light-transmitting portion 513 and the outer circumferential surface of the light-absorbing portion 523 may be welded to and integrated with each other.

Accordingly, compared to other coupling methods, it is possible to precisely and reliably couple the lower pipe 52 and the upper pipe 51 to each other and to seal a gap therebetween. Accordingly, it is possible to prevent foreign substances, such as liquid, or air from being introduced into a gap between the lower pipe 52 and the upper pipe 51. In addition, the flow efficiency of air passing through the insertion space 54 may be improved. In addition, the process of manufacturing the device may be automated, and thus processability may be improved.

The thickness of the light-transmitting portion 513 may be less than the thickness of the circumference 510 of the upper pipe 51, which is formed around the light-transmitting portion 513, in the radial direction. The thickness of the light-transmitting portion 513 may be less than the thicknesses of the upper circumference 511 of the upper pipe 51 and the lower circumference 512 thereof. The light-transmitting portion 513 may be formed in such a manner that the outer circumferential surface of the circumference 510 of the upper pipe 51 is depressed in the radially inward direction.

Accordingly, the transmittance of the laser beam L through the light-transmitting portion 523, which is subjected to welding, may be increased.

The outer circumferential surface of the lower pipe 52 and the inner circumferential surface of the upper pipe 51 may overlap and support each other in the vertical direction. The lower pipe 52 may include a first support rib 525 protruding in the radially outward direction from the outer circumferential surface of the circumference 521. The first support rib 525 may be oriented in the upward direction. The first support rib 525 may extend in the circumferential direction. The first support rib 525 may be formed adjacent to the upper side or the lower side of the light-absorbing portion 523. The first support rib 525 may form a step on the outer circumferential surface of the circumference 521 of the lower pipe 52.

The upper pipe 51 may include a second support rib 515 protruding in the radially inward direction from the inner circumferential surface of the circumference 510. The second support rib 515 may be oriented in the downward direction. The second support rib 515 may extend in the circumferential direction. The second support rib 515 may be formed adjacent to the upper side and/or the lower side of the inner circumferential surface of the light-transmitting portion 513. The second support rib 515 may form a step on the inner circumferential surface of the circumference 510 of the upper pipe 51.

The first support rib 525 and the second support rib 515 may be formed at positions corresponding to each other. The second support rib 515 may be in contact with or coupled to the first support rib 525. The second support rib 515 and the first support rib 525 may support each other in the vertical direction.

Referring to FIGS. 1 to 9, an aerosol-generating device 100 in accordance with one aspect of the present disclosure may include a heating assembly configured to surround a first insertion space that is open at an upper portion and at a lower portion; a lower pipe disposed below the heating assembly to be parallel to the heating assembly and to support a lower end of the heating assembly; an upper pipe configured to support an upper end of the heating assembly and extending downwards to cover a circumference of the heating assembly, the upper pipe having a circumference overlapping a circumference of the lower pipe along a radial direction; a light-transmitting portion located on one of the lower pipe or the upper pipe at a position corresponding to the overlap; and a light-absorbing portion located on the other one of the lower pipe or the upper pipe at the position corresponding to the overlap and integrally coupled to an inner circumferential surface of the light-transmitting portion.

In addition, in accordance with another aspect of the present disclosure, wherein the upper pipe may cover an outer circumferential surface of the heating assembly and an outer circumferential surface of the lower pipe, wherein the light-absorbing portion may be located on the lower pipe, and wherein the light-transmitting portion may be located on the upper pipe and surrounds an outer circumferential surface of the light-absorbing portion.

In addition, in accordance with another aspect of the present disclosure, wherein the light-transmitting portion may have a thickness less than a thickness of the circumference of the upper pipe around the light-transmitting portion.

In addition, in accordance with another aspect of the present disclosure, wherein the light-transmitting portion may be configured such that an outer circumferential surface of the circumference of the upper pipe is depressed along a radially inward direction.

In addition, in accordance with another aspect of the present disclosure, the light-absorbing portion may have an outer circumferential surface fused to the inner circumferential surface of the light-transmitting portion.

In addition, in accordance with another aspect of the present disclosure, the outer circumferential surface of the light-absorbing portion may be fused to the inner circumferential surface of the light-transmitting portion upon absorbing a laser beam radiated from the outside of the light-transmitting portion.

In addition, in accordance with another aspect of the present disclosure, the light-transmitting portion may be made of a light transmissive plastic, and the light-absorbing portion may be made of a light absorptive plastic.

In addition, in accordance with another aspect of the present disclosure, the light-transmitting portion may have a light transmittance of 30% or more.

In addition, in accordance with another aspect of the present disclosure, the aerosol-generating device may further include a pipe flange disposed above the heating assembly and protruding along a radially inward direction from an inner circumferential surface of the upper pipe to support the upper end of the heating assembly.

In addition, in accordance with another aspect of the present disclosure, wherein the lower pipe may have an upper surface supporting the lower end of the heating assembly.

In addition, in accordance with another aspect of the present disclosure, wherein the lower pipe may have a second insertion space defined therein, the second insertion space being in communication with the first insertion space and extending downwards from the first insertion space.

In addition, in accordance with another aspect of the present disclosure, the lower pipe may include a stick supporter covering at least a portion of the lower end of the second insertion space.

In addition, in accordance with another aspect of the present disclosure, the lower pipe may include a connecting passage, which is surrounded by the stick supporter and allows the second insertion space to communicate with the outside of the lower pipe.

In addition, in accordance with another aspect of the present disclosure, the lower pipe and the upper pipe may overlap and support each other along the vertical direction.

In addition, in accordance with another aspect of the present disclosure, wherein the lower pipe may comprise a first support rib protruding along a radially outward direction from the outer circumferential surface of the lower pipe to be oriented in an upward direction, and wherein the upper pipe may comprise a second support rib protruding along a radially inward direction from an inner circumferential surface of the upper pipe to be oriented in a downward direction and to be coupled to the first support rib.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a heating assembly configured to surround a first insertion space that is open at an upper portion and at a lower portion;
a lower pipe disposed below the heating assembly to be parallel to the heating assembly and to support a lower end of the heating assembly;
an upper pipe configured to support an upper end of the heating assembly and extending downwards to cover a circumference of the heating assembly, the upper pipe having a circumference overlapping a circumference of the lower pipe along a radial direction;
a light-transmitting portion located on one of the lower pipe or the upper pipe at a position corresponding to the overlap; and
a light-absorbing portion located on the other one of the lower pipe or the upper pipe at the position corresponding to the overlap and integrally coupled to an inner circumferential surface of the light-transmitting portion.

2. The aerosol-generating device according to claim 1, wherein the upper pipe covers an outer circumferential surface of the heating assembly and an outer circumferential surface of the lower pipe,
wherein the light-absorbing portion is located on the lower pipe, and
wherein the light-transmitting portion is located on the upper pipe and surrounds an outer circumferential surface of the light-absorbing portion.

3. The aerosol-generating device according to claim 2, wherein the light-transmitting portion has a thickness less than a thickness of the circumference of the upper pipe around the light-transmitting portion.

4. The aerosol-generating device according to claim 3, wherein the light-transmitting portion is configured such that an outer circumferential surface of the circumference of the upper pipe is depressed along a radially inward direction.

5. The aerosol-generating device according to claim 2, further comprising:
a pipe flange disposed above the heating assembly and protruding along a radially inward direction from an inner circumferential surface of the upper pipe to support the upper end of the heating assembly.

6. The aerosol-generating device according to claim 5, wherein the lower pipe has an upper surface supporting the lower end of the heating assembly.

7. The aerosol-generating device according to claim 2, wherein the lower pipe has a second insertion space defined therein, the second insertion space being in communication with the first insertion space and extending downwards from the first insertion space.

8. The aerosol-generating device according to claim 7, wherein the lower pipe comprises a stick supporter covering at least a portion of a lower end of the second insertion space.

9. The aerosol-generating device according to claim 8, wherein the lower pipe further comprises a connecting passage surrounded by the stick supporter, the connecting passage allowing the second insertion space to communicate with an outside of the lower pipe.

10. The aerosol-generating device according to claim 2, wherein the lower pipe and the upper pipe overlap and support each other along a vertical direction.

11. The aerosol-generating device according to claim 10, wherein the lower pipe comprises a first support rib protruding along a radially outward direction from the outer circumferential surface of the lower pipe to be oriented in an upward direction, and
wherein the upper pipe comprises a second support rib protruding along a radially inward direction from an inner circumferential surface of the upper pipe to be oriented in a downward direction and to be coupled to the first support rib.

12. The aerosol-generating device according to claim 1, wherein the light-absorbing portion has an outer circumferential surface fused to the inner circumferential surface of the light-transmitting portion.

13. The aerosol-generating device according to claim 12, wherein the outer circumferential surface of the light-absorbing portion is fused to the inner circumferential surface of the light-transmitting portion upon absorbing a laser beam radiated from outside the light-transmitting portion.

14. The aerosol-generating device according to claim 1, wherein the light-transmitting portion comprises a light transmissive plastic, and
wherein the light-absorbing portion comprises a light absorptive plastic.

15. The aerosol-generating device according to claim 1, wherein the light-transmitting portion has a light transmittance greater than or equal to 30%.
